(19) United States
(12) Patent Application Publication
(10) Pub. No.: US 2017/0133188 A1
(43) Pub. Date: May 11, 2017

(54) Fuse Discharge Filter Apparatus with Expanded Copper Filter Element

(71) Applicant: Eaton Corporation, Cleveland, OH (US)

(72) Inventor: Ramon Javier Ojeda, Imperial, PA (US)

(73) Assignee: EATON CORPORATION, Cleveland, OH (US)

(21) Appl. No.: 14/937,918

(22) Filed: Nov. 11, 2015

(51) Int. Cl. H01H 85/43; H01H 85/175

(52) U.S. Cl. CPC H01H 85/43; H01H 85/175

(57) ABSTRACT

A fuse discharge filter is provided. The fuse discharge filter includes a housing assembly defining an enclosed passage, a coil including a number of sheets of expanded metal. The expanded metal coil is substantially disposed in the housing assembly enclosed passage.

### BACKGROUND OF THE INVENTION

Field of the Invention

The disclosed and claimed concept relates to fuse assemblies and, more specifically, to a fuse discharge filter including an expanded metal coil.

Background Information

A fuse assembly includes a fusible element disposed between, and in electrical communication with, two terminals. When an overcurrent condition occurs, the heat generated as the current passes through the fusible element causes the fusible element to melt thereby electrically separating the two terminals. The melting of the fusible element creates a “debris cloud.” A “debris cloud,” as used herein, means a quantity of heated gas and residual metal that expands rapidly and which is accompanied by a loud sound. Fuses and other electrical components utilize a discharge filter to ameliorate the effects of a debris cloud. In one embodiment, a fuse discharge filter includes a quantity of mesh material disposed in an enclosed passage. The mesh material may be disposed in layers or in the form of a coil. In this configuration, the mesh material defines a plurality of labyrinthine passages within the fuse discharge filter. As the debris cloud passes through the labyrinthine passages, the intensity of the debris cloud is reduced. That is, the speed of the gasses, the temperature of the gasses and the sonic volume of the debris cloud is reduced.

Fuse discharge filters, however, have several disadvantages generally related to the mesh material. That is, the mesh material is expensive and may be easily damaged.

### SUMMARY OF THE INVENTION

The disclosed and claimed fuse discharge filter solves the problems of the known art by providing an expanded metal coil. An expanded metal coil is strong and inexpensive, or as used herein, a “pollent,” material. A fuse discharge filter including an expanded metal coil forms a plurality of labyrinthine passages within the fuse discharge filter through which the debris cloud must pass. In an exemplary embodiment, the disclosed and claimed fuse discharge filter includes a housing assembly defining an enclosed passage, a coil including a number of sheets of expanded metal. The expanded metal coil is substantially disposed in the housing assembly enclosed passage. In this configuration, and by using a pollent material, the disclosed fuse discharge filter solves the problems stated above.

### BRIEF DESCRIPTION OF THE DRAWINGS

A full understanding of the invention can be gained from the following description of the preferred embodiments when read in conjunction with the accompanying drawings in which:

FIG. 1 is a partially schematic side cross-sectional view of a fuse assembly.

FIG. 2 is a partially schematic side cross-sectional view of a fuse discharge filter assembly.

FIG. 3 is a partially schematic exploded isometric view of a fuse discharge filter assembly.

FIGS. 4A and 4B show a configurable planar member in a first and second configuration, respectively.

FIG. 5 is an isometric view of a coil in a loose spiral configuration.

### DESCRIPTION OF THE PREFERRED EMBODIMENTS

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” means that one component is coupled with another component in an essentially temporary manner. That is, the two components are coupled in such a way that the joining or separation of the components is easy and would not damage the components. For example, two components secured to each other with a limited number of readily accessible fasteners are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, a “coupling assembly” includes two or more couplings or coupling components. The components of a coupling or coupling assembly are generally not part of the same element or other component. As such, the components of a “coupling assembly” may not be described at the same time in the following description. As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the statement that two or more parts or components “engage” one another shall mean that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate.

As used herein, the word “unitary” means a component that is created as a single piece or unit. That is, a component that includes pieces that are created separately and then coupled together as a unit is not a “unitary” component or body. As used herein, the term “number” shall mean one or an integer greater than one (i.e., a plurality).

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, “pollent” means strong and/or inexpensive. That is, a “pollent” material is strong and inexpensive relative to a mesh material made from a similar base material such as, but not limited to copper. Further, as used herein, a “mesh material,” i.e., a material including interleaved strands, is an expensive material in that the process of weaving the strands increases the cost of the mesh material. Thus, a mesh material is not, as used herein, a “pollent” material.

As used herein, an “enclosed passage” is a passage defined by a barrier generally impervious to fluids which includes a number of inlets defined by a structure and a number of outlets defined by a structure wherein the outlet(s) is/are spaced from the inlet(s), wherein a fluid passing through the “enclosed passage” travels from the inlet(s) to the outlet(s).

As used herein, a “use configuration” is a configuration in which an expanded metal construct that is capable of being in more than one configuration is intended to be used, i.e., a configuration in which the construct is intended to perform a defined function. A “use configuration” is not a “storage/shipping configuration.” That is, a construct capable of being in more than one configuration may be capable of being in configurations such as, but not limited to, a manufacturing configuration, a storage/shipping configuration, and a use configuration. The “storage/shipping configuration” is, as used herein, an intermediate or intermediate configuration and is not a configuration in which the construct is intended to perform a defined function. By way of a non-limiting example, a cardboard box may be manufactured by initially being cut from a sheet of cardboard; this is, as used herein, a “manufacturing configuration.” The cut cardboard may be folded so as to occupy less area/volume, but not into a configuration wherein the cardboard box is intended to be used as a container; this is a “storage/shipping configuration.” When the cardboard box is reconfigured to be a container, the cardboard box is in the “use configuration.” Further, the fact that the cardboard box in the “storage/shipping configuration” could, ostensibly, be used to enclose an object, such a sheet of paper, does not make the “storage/shipping configuration” a “use configuration.” That is, as used herein, the ostensible capability of a construct to be used in a manufacturing configuration or a storage/shipping configuration does not make that configuration a “use configuration.” As used herein, when the construct is in a configuration wherein it is intended to be used, then it is in a “use configuration.” Further, to be in a “use configuration” the construct must be used in that configuration. Thus, as used herein, an expanded metal construct in a “storage/shipping configuration” that is, ostensibly capable of being used in that configuration is not in a “use configuration.” Only when the construct is used in a specific configuration does that configuration become a “use configuration.” Further, as used herein, a mesh construct is not an expanded metal construct. Accordingly, a mesh construct, as well as any other non-expanded metal construct, cannot be in a “use configuration” as that term is used herein.

As used herein, a “coil” is a construct formed by a number of configurable planar members wrapped in concentric spiral layers about a central axis. As used herein, “configurable planar members” are individual constructs than may be disposed in a planar configuration. By way of a non-limiting example, an elongated wire may be wrapped about a spool, but is not, as used herein, a “coil” because an individual elongated wire may not be disposed in a planar configuration. Conversely, a sheet of aluminum foil wrapped about a spool is, as used herein, a “coil” because the sheet of foil may be disposed in a planar configuration. Further, as used herein, a “coil” includes shapes other than a curvilinear spiral. That is, for example, a sheet of aluminum foil bent at generally ninety degree angles, wherein the length of foil between each angle increases forms a square spiral and is included in the definition of “coil.”

As used herein, a “coil” includes “layers” of the configurable planar members disposed in a spiral configuration wherein a “layer” is a portion of the configurable planar member disposed at about the same distance from a center axis. That is, for example, a line drawn radially outward from the axis about which a single configurable planar member is wrapped would pass through the single configurable planar member multiple times. Even though there is a single configurable planar member, each instance of the line passing through the single configurable planar member disposed in a spiral configuration defines a “layer.” The innermost “layer” of a configurable planar member disposed in a spiral configuration begins at the innermost end of a configurable planar member disposed in a spiral configuration. Thereafter, each “layer” begins/ends at a location disposed radially outwardly from the innermost end of that configurable planar member disposed in a spiral configuration.

As used herein, a “single member coil” is a coil formed by a single “configurable planar member.” As used herein, a “limited member coil” is a coil formed by between one and ten “configurable planar members.”

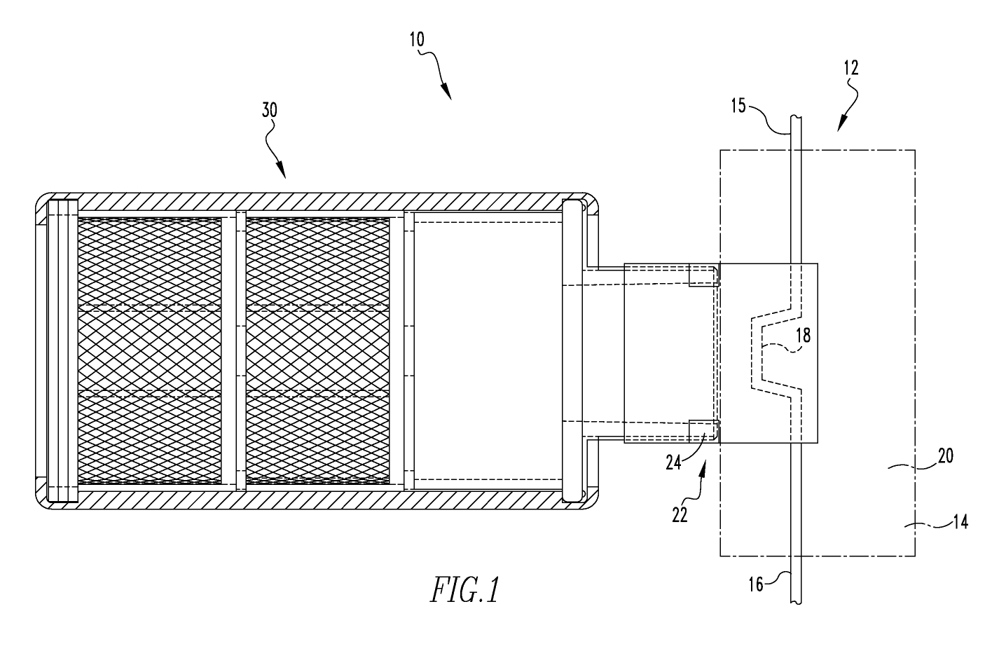

As shown in FIG. 1, a fuse assembly 10, hereinafter “fuse 10,” includes a fuse portion 12 (shown schematically) and a fuse discharge filter assembly 30. The fuse portion 12 includes a mounting assembly 14, a number of terminals 15, 16 (two shown) and a fusible element 18. In an exemplary embodiment, the mounting assembly 14 includes a housing 20 defining a first filter coupling component 22. As shown in the exemplary embodiment, the first filter coupling component 22 is an externally threaded collar 24.

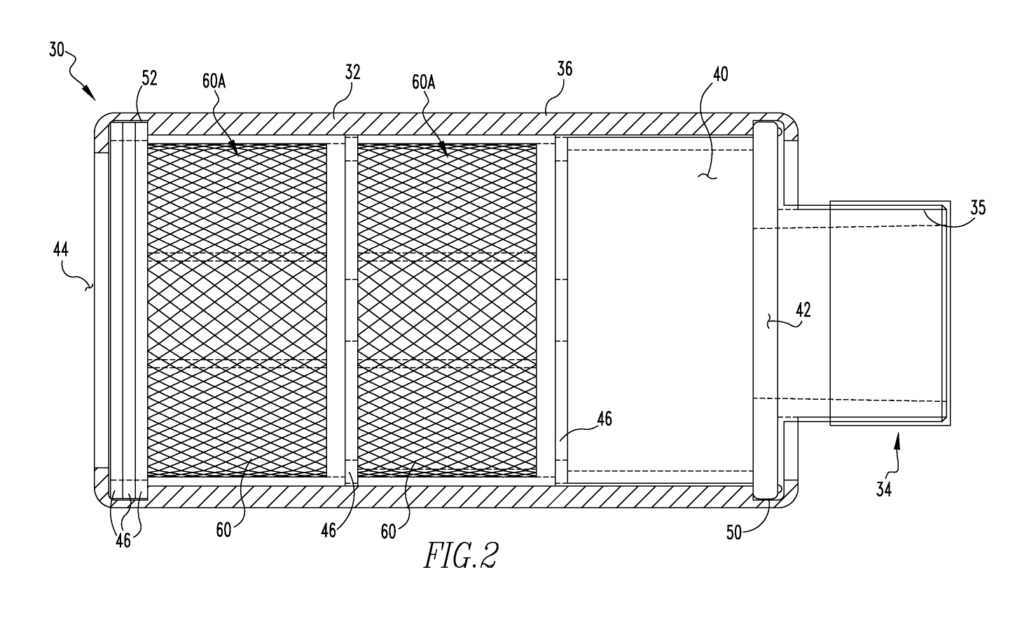

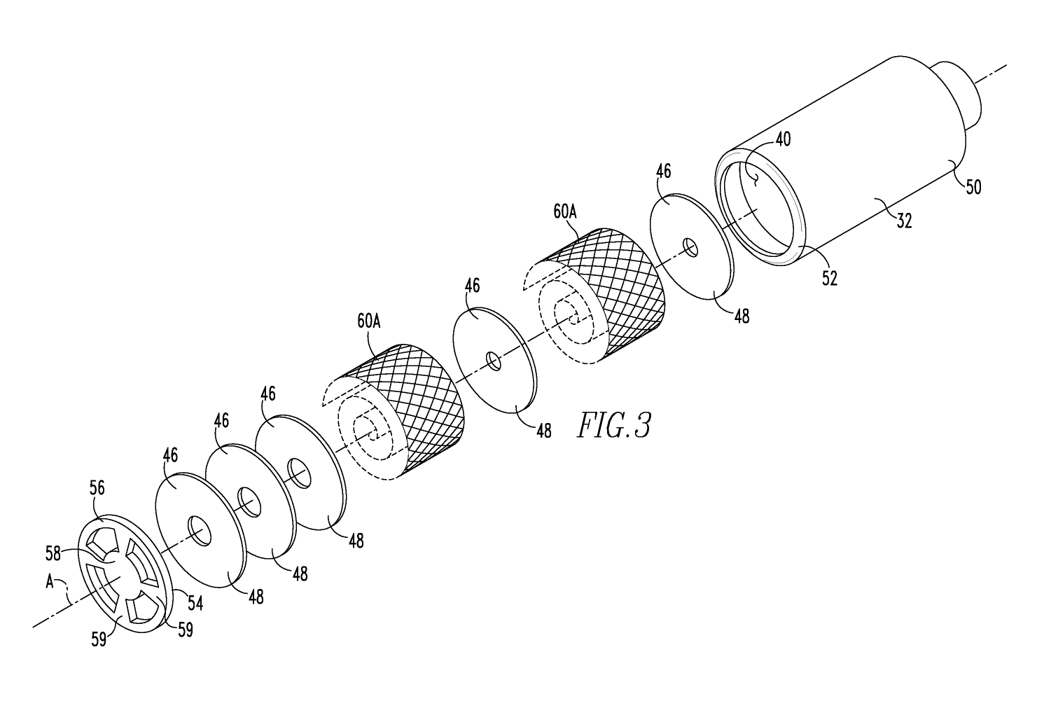

The fuse discharge filter assembly 30, shown in FIGS. 2 and 3, includes a housing assembly 32, a number of baffles 46 (five shown), and a number of coils 60 (two shown). In an exemplary embodiment, as shown, the fuse discharge filter assembly housing assembly 32 is generally cylindrical. The fuse discharge filter assembly housing assembly 32 includes a second filter coupling component 34 which, in an exemplary embodiment, is a threaded passage 35. The second filter coupling component 34 corresponds to the first filter coupling component 22 and is structured to be coupled thereto. Further, the fuse discharge filter assembly housing assembly 32 defines an enclosed passage 40. Thus, the fuse discharge filter assembly housing assembly 32 includes an outer diameter and an inner diameter. In an exemplary embodiment, the enclosed passage 40 has a single inlet 42 and a number of outlets 44. That is, the fuse discharge filter assembly housing assembly 32 includes a generally cylindrical sidewall 36 that is by a barrier generally impervious to fluids. The fuse discharge filter assembly housing assembly 32, i.e., sidewall 36, includes a first end 50 and a second end 52. The fuse discharge filter assembly housing assembly first end 50 defines an inlet and the fuse discharge filter assembly housing assembly second end 52 defines an outlet. As discussed below, the fuse portion 12 is coupled to the second filter coupling component 34 at the fuse discharge filter assembly housing assembly first end 50. When the fusible element 18 is subjected to an overcurrent condition, the fusible element 18 element melts and creates a debris cloud that passes through the enclosed passage 40. Thus, the enclosed passage 40 and the discharge filter assembly housing assembly 32 have a flow direction and an upstream end and a downstream end. That is, the fuse discharge filter assembly housing assembly first end 50 is the upstream end and the fuse discharge filter assembly housing assembly second end 52 is the downstream end.

In an exemplary embodiment, the fuse discharge filter assembly housing assembly 32 includes a cap 54 disposed at the fuse discharge filter assembly housing assembly second end 52. In an exemplary embodiment, the cap is unitary with the cylindrical sidewall 36 and is, as used herein, a “unitary cap.” That is, a “unitary cap” means a cap that is unitary with the body that is capped. The cap 54 includes a generally circular collar 56, a hub 58 and a number of spokes 59. In an exemplary embodiment, the spokes 59 radially extend from the hub 58 to the collar 56 whereby the hub 58 is generally centrally disposed at, and about (i.e., around), the center of the collar 56. As discussed below, the hub 58 is sized to correspond to an expanded metal coil central cavity 80.

Each baffle 46, in an exemplary embodiment, includes a generally toroidal body 48. Each baffle 46, i.e., each toroidal body 48, includes an inner diameter and an outer diameter. The outer diameter of each baffle 46 generally corresponds to the inner diameter of the fuse discharge filter assembly housing assembly 32. The inner diameter of each baffle 46 generally corresponds to the expanded metal coil central cavity 80, discussed below.

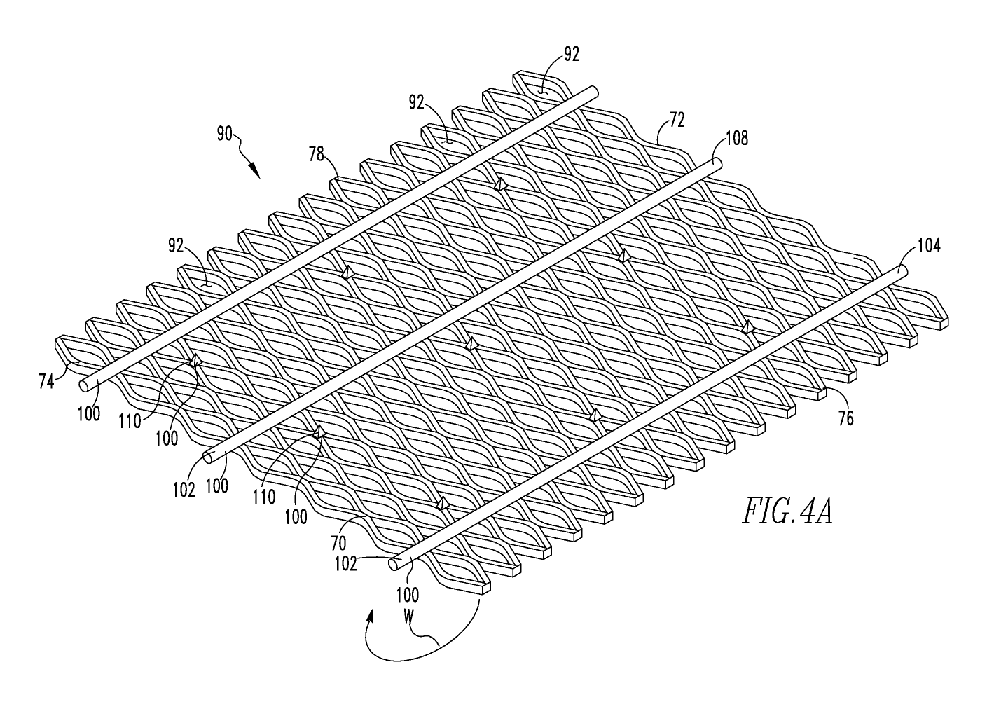

Each coil 60 is substantially similar and only one will be described. A coil, as defined above, includes a number of configurable planar members 70, as shown in FIGS. 4A and 4B. Each configurable planar member 70 is reconfigurable between a generally planar, first configuration (FIG. 4A), and a generally spiral, or coiled, second configuration (FIG. 4B). It is noted that the configurable planar member 70 does not have to be placed into each configuration to establish the configurable planar member 70 as a configurable planar member 70. Rather, as used herein, if the configurable planar member 70 is capable of being disposed in the two identified configurations, then it is a configurable planar member 70. In an exemplary embodiment, each configurable planar member 70 is, in the first configuration, generally rectangular. In this embodiment, each configurable planar member 70 includes an inlet side 72, an outlet side 74, an inner longitudinal side 76, and an outer longitudinal side 78. When a configurable planar member 70 is configured in the second configuration, the configurable planar member 70 is wrapped, as shown by arrow “W,” (FIG. 4A) about, i.e., around, an axis “A” (FIG. 4B) disposed generally parallel to the configurable planar member inner longitudinal side 76 and configurable planar member outer longitudinal side 78. In an exemplary embodiment, the configurable planar member inner longitudinal side 76 is spaced from the axis A; thus, the coil 60 defines an elongated central cavity 80 (FIG. 4B). The longitudinal axis A of the cavity 80 is generally aligned, i.e., overlaps, the axis A. A coil 60 wherein the number of configurable planar members 70 includes one or more sheets of expanded metal 90 (sheets shown in FIG. 4A) is described hereinafter as, and as used herein is, an “expanded metal coil” 60A. It is noted that the expanded metal coils are shown schematically in FIGS. 1-3; FIG. 4A shows an exemplary embodiment of a sheet of expanded metal in a planar configuration. In an exemplary embodiment, the sheets of expanded metal 90 are copper. Each sheet of expanded metal 90 includes a plurality of openings 92 (hereinafter “expanded metal openings” 92). Sheets of expanded metal 90 are strong and inexpensive; therefore, sheets of expanded metal 90 are a pollent material. The method of making sheets of expanded metal 90 is well known and produces substantially planar configurable planar members 70 (when disposed in the first configuration). In an exemplary embodiment, the number of configurable planar members 70 is a single sheet of expanded metal 90, i.e., a “single member coil,” or includes between one and ten sheets of expanded metal 90, i.e., a “limited member coil.” That is, an expanded metal coil 60A may be one of a single member coil or a limited member coil, as those terms are defined above. It is noted that the Figures disclose the expanded metal coil 60A as having a generally cylindrical, i.e., circular, shape; as noted above, the expanded metal coil 60A is not limited to a generally cylindrical shape. Further, the expanded metal coil 60A is, in an exemplary embodiment, in a use configuration. That is, the expanded metal coil 60A, as described below, is used in the fuse discharge filter assembly 30. Thus, this configuration of the coil, as defined herein, is a “use configuration.”

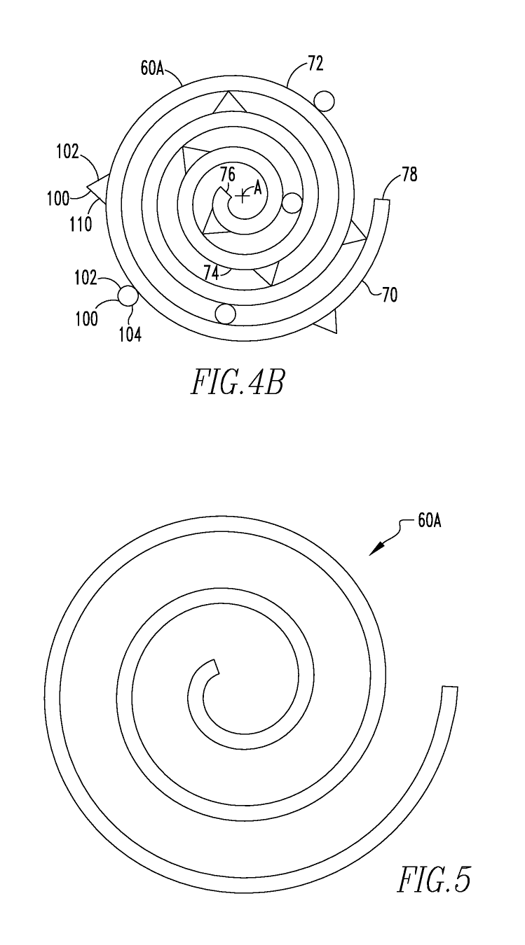

In an exemplary embodiment, the use configuration of the expanded metal coil 60A includes layers wherein a portion of one concentric spiral layer is spaced from another, immediately adjacent concentric spiral layer. In a first exemplary embodiment, shown in FIG. 5, the expanded metal coil 60A is disposed in a loose spiral configuration, i.e., without offset elements 100, discussed below. As used herein, a “loose spiral configuration” is a configuration wherein the configurable planar member(s) 70 of the expanded metal coil 60A is/are wrapped about a central axis A so that a gap exists between a number of immediately adjacent layers of the expanded metal coil 60A. In an exemplary embodiment, the expanded metal coil 60A does not extend to the central axis A, but is spaced therefrom thereby defining expanded metal coil central cavity 80. In another exemplary embodiment, the expanded metal coil 60A includes a number of offset elements 100 (FIGS. 4A and 4B). In an exemplary embodiment, each offset element 100 is a generally rigid lug 102 coupled to, or unitary with, each configurable planar member 70. As used herein, an offset element 100 that is coupled to the configurable planar member 70 is a “non-unitary offset element,” and, an offset element 100 that is unitary with, i.e., formed as part of, the configurable planar member 70 is a “unitary offset element.” Each lug 102 is disposed out of the plane of each configurable planar member 70 when the configurable planar member 70 is in the first configuration. In an exemplary embodiment, each lug 102 is limited to a small, discrete body 104 such as but not limited to a small generally circular body 104. In another embodiment, each lug 102 is an elongated body 106. When a lug 102 is an elongated body 106 the elongated body 106 is coupled to the configurable planar member 70 in a direction other than perpendicular to the axis A. In an exemplary embodiment, each elongated body 106 is coupled to the configurable planar member 70 in a direction generally parallel to the axis A. In an exemplary embodiment, wherein each lug 102 is unitary with an associated configurable planar member 70, the lugs 102 are, hereinafter and as used herein, a “dimple” 110. In an exemplary embodiment, each dimple 110 is limited to a small, discrete area, such as, but not limited to, a small circular area. In an exemplary embodiment, a number of offset elements 100 are disposed along each configurable planar member inlet side 72 and each configurable planar member outlet side 74.

Further, the offset elements 100, in an exemplary embodiment, act as turbulators and/or a configurable planar member 70 includes a turbulator 108. As used herein, a “turbulator” means a construct structured to create a turbulent fluid flow at a selected location. That is, an offset element 100 and/or a turbulator 108 is/are, in an exemplary embodiment, structured to create a turbulent fluid flow at a location, such as, but not limited to, adjacent an expanded metal opening 92. In this configuration, the offset element 100 and/or a turbulator 108 creates a turbulent flow adjacent an expanded metal opening 92, thereby directing some of the flow toward, and through, the adjacent expanded metal opening 92 while another portion of the fluid flow is directed to another expanded metal opening 92. The fuse discharge filter assembly 30 is assembled as follows. The one or more sheets of expanded metal 90 is/are wrapped about an axis A, as described above, thereby forming an expanded metal coil 60A. In an exemplary embodiment, the offset elements 100 separate a number of layers at each configurable planar member inlet side 72 and each configurable planar member outlet side 74. In this configuration, the expanded metal openings 92 form labyrinthine passages through the expanded metal coil 60A.

Further, in an exemplary embodiment, the expanded metal coil 60A is in a use configuration when the expanded metal coil 60A has a thickness (inlet side 72 to outlet side 74) of between about 1.5 inches to 2.0 inches, or about 1.74 inches; an outer diameter of between about 3.25 inches to 3.75, or about 3.5 inches; an inner diameter of between about 0.75 inch to 1.25 inches, or about 1.0 inch. In an exemplary embodiment, the sheet of expanded metal 90 has a mesh (U.S. Standard) size of between about 3.5 to 9, or, in one exemplary embodiment 4.0, or, in another exemplary embodiment, 5.0 A coil 60 configured as stated above solves the problems noted above. That is, in a use configuration, the expanded metal coil 60A is structured to act as a filter. It is noted that, as used herein, expanded metal in a storage configuration does not function as a filter and such a function is unknown.

In an exemplary embodiment, there are two expanded metal coils 60A. The expanded metal coils 60A are disposed in the fuse discharge filter assembly housing assembly 32, i.e., within enclosed passage 40, with a number of baffles 46 disposed upstream and downstream of each expanded metal coil 60A. That is, in an exemplary embodiment, a first baffle 46′ is disposed adjacent fuse discharge filter assembly housing assembly inlet 42 and upstream of an expanded metal coil 60A. An upstream expanded metal coil 60A′ is disposed just downstream of the first baffle 46′. A second baffle 46″ is disposed downstream of the upstream expanded metal coil 60A′. A downstream expanded metal coil 60A″ is disposed downstream of the second baffle 46″. The remaining baffles 46 are disposed between the downstream expanded metal coil 60A″ and cap 54. Further, in this configuration, hub 58 is disposed over, that is, covering (not above), the expanded metal coil central cavity 80. In this configuration, a debris cloud initially passes into cavity 80 and must pass through various expanded metal openings 92, as discussed below. The fuse discharge filter assembly 30 is coupled to the fuse portion 12 by coupling the first filter coupling component 22 and the second filter coupling component 34. In this configuration, when the fusible element 18 fuses, the resulting debris cloud must pass though the fuse discharge filter assembly 30. The debris cloud must pass through various expanded metal openings 92. That is, the debris cloud is separated and different portions pass through different expanded metal openings 92. In this configuration, the fuse discharge filter assembly 30 solves the problems stated above in that the fuse discharge filter assembly 30 intensity of the debris cloud is reduced while including a pollent material for the coil 60.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof

What is claimed is:

1. A fuse discharge filter assembly for a fuse, said fuse including a fusible element and a first filter coupling component, said fuse discharge filter assembly comprising:
a housing assembly defining an enclosed passage;
a coil including a number of sheets of expanded metal; and
said expanded metal coil substantially disposed in said housing assembly enclosed passage.

2. The fuse discharge filter assembly of claim 1 wherein said expanded metal coil is in a use configuration.

3. The fuse discharge filter assembly of claim 1 wherein said expanded metal coil is one of a single member coil or a limited member coil.

4. The fuse discharge filter assembly of claim 1 wherein:
said expanded metal coil includes a number of offset elements;
each offset element structured to space adjacent layers of expanded metal in said expanded metal coil.

5. The fuse discharge filter assembly of claim 4 wherein each said offset element is one of a unitary offset element or a non-unitary offset element.

6. The fuse discharge filter assembly of claim 4 wherein said expanded metal coil includes a number of turbulators.

7. The fuse discharge filter assembly of claim 1 wherein said sheets of expanded metal are copper.

8. The fuse discharge filter assembly of claim 1 wherein said expanded metal coil defines a central cavity.

9. The fuse discharge filter assembly of claim 8 wherein:
said housing assembly includes an first end and a second end;
said housing assembly second end including a cap;
said housing assembly second end cap including a hub and a number of spokes;
said housing assembly second end cap sized to generally correspond to said expanded metal coil central cavity; and
said housing assembly second end cap disposed generally over said expanded metal coil central cavity.

10. The fuse discharge filter assembly of claim 1 wherein said expanded metal coil is disposed in a loose spiral configuration.

11. A fuse assembly comprising:
a mounting;
a fusible element coupled to said mounting;
a first filter coupling component coupled to said mounting;
a fuse discharge filter assembly including a housing assembly and a coil;
said housing assembly defining an enclosed passage and a second filter coupling component;
said coil including a number of sheets of expanded metal;
said expanded metal coil substantially disposed in said housing assembly enclosed passage; and
said first filter coupling component coupled to said second filter coupling component.

12. The fuse assembly of claim 11 wherein said expanded metal coil is in a use configuration.

13. The fuse discharge filter assembly of claim 11 wherein said expanded metal coil is one of a single member coil or a limited member coil.

14. The fuse discharge filter assembly of claim 11 wherein:
said expanded metal coil includes a number of offset elements; and
each offset element structured to space adjacent layers of expanded metal in said expanded metal coil.

15. The fuse discharge filter assembly of claim 14 wherein each said offset element is one of a unitary offset element or a non-unitary offset element.

16. The fuse discharge filter assembly of claim 14 wherein said expanded metal coil includes a number of turbulators.

17. The fuse discharge filter assembly of claim 11 wherein said sheets of expanded metal are copper.

18. The fuse discharge filter assembly of claim 11 wherein said expanded metal coil defines a central cavity.

19. The fuse discharge filter assembly of claim 18 wherein:
said housing assembly includes an first end and a second end;
said housing assembly second end including a cap;
said housing assembly second end cap including a hub and a number of spokes;
said housing assembly second end cap sized to generally correspond to said expanded metal coil central cavity; and
said housing assembly second end cap disposed generally over said expanded metal coil central cavity.

20. The fuse discharge filter assembly of claim 11 wherein said expanded metal coil is disposed in a loose spiral configuration.
